(19) United States
(12) Patent Application Publication
(10) Pub. No.: US 2025/0388176 A1
(43) Pub. Date: Dec. 25, 2025

(54) VEHICLE HAVING TUNABLE HITCH MOUNTED CARGO BOX

(71) Applicant: Ford Global Technologies, LLC, Dearborn, MI (US)

(72) Inventors: Michael Stephen Sylvester, Allen Park, MI (US); Dean Carbis, Bloomfield Hills, MI (US)

(73) Assignee: Ford Global Technologies, LLC, Dearborn, MI (US)

(21) Appl. No.: 18/748,932

(22) Filed: Jun. 20, 2024

(51) Int. Cl. B60R 9/06; B60D 1/62

(52) U.S. Cl. CPC B60R 9/06; B60D 1/62

(57) ABSTRACT

A motor vehicle has a hitch mounted to a rear end of the motor vehicle. A vehicle power management system is configured to detect power or energy levels of the motor vehicle and to generate feedback indicative of aerodynamics of the motor vehicle. A cargo box carrier is mounted to the hitch. The cargo box carrier has an adjustable cargo box and an actuator configured to move the cargo box relative to the motor vehicle. A controller controls the actuator to move the cargo box based on feedback from the vehicle power management system.

### FIELD OF THE DISCLOSURE

The present disclosure generally relates to motor vehicles equipped with a cargo box carrier, and more particularly relates to a motor vehicle having an adjustable cargo box mounted to a hitch on the motor vehicle.

### BACKGROUND OF THE DISCLOSURE

Motor vehicles frequently transport cargo box carriers on the exterior of the motor vehicle. For example, a cargo box carrier may be mounted to a hitch at the rear end of the motor vehicle and used to transport cargo. Typically, the cargo box carrier has a drop bar that is fixedly connected to the hitch on the motor vehicle. It may be desirable to provide for an arrangement of a cargo box carrier on a motor vehicle that is adjustable to enhance the aerodynamics during transport.

### SUMMARY OF THE DISCLOSURE

According to a first aspect of the present disclosure, a motor vehicle has a hitch mounted to a rear end of the motor vehicle. A vehicle power management system is configured to detect power or energy levels of the motor vehicle and to generate feedback indicative of aerodynamics of the motor vehicle. A cargo box carrier is mounted to the hitch. The cargo box carrier has an adjustable cargo box and an actuator configured to move the cargo box relative to the motor vehicle. A controller controls the actuator to move the cargo box based on feedback from the vehicle power management system.

Embodiments of the first aspect of the present disclosure can include any one or a combination of the following features:
the controller actuates the cargo box from a first position to a second position and determines a change in power due to aerodynamic drag, and wherein the controller further selects one of the first or second positions based on the change in power indicative of least aerodynamic drag;
the actuator actuates the cargo box along a longitudinal axis of the motor vehicle between rearward and forward positions;
a yaw sensor for sensing yaw of the motor vehicle, wherein the controller further determines the position of the cargo box based on the sensed yaw;
the sensed yaw is an estimated yaw angle;
the sensed yaw is indicative of a crosswind load on the motor vehicle;
a vehicle speed sensor, wherein the controller determines when the motor vehicle is parked and further detects a request to open the rear liftgate, and wherein the controller actuates the actuator to move the cargo box to a rearward position;
the cargo box carrier further comprises a draw bar configured to mount to the hitch;
the actuator comprises an electric motor and a screw jack;
the cargo box has a power cable connected to an electrical connector on the motor vehicle; and
the electrical connector comprises a trailer connector electrical plug.

According to a second aspect of the present disclosure, a motor vehicle has a hitch mounted to a rear end of the motor vehicle. A vehicle power management system is configured to detect power or energy levels of the motor vehicle and to generate feedback indicative of aerodynamics of the motor vehicle. A cargo box carrier having a draw bar connected to the hitch and an adjustable cargo box coupled to the draw bar. The cargo box carrier has an actuator configured to move the cargo box relative to the motor vehicle between a forward position and a rearward position and a controller for controlling the actuator to move the cargo box based on feedback from the vehicle power management system.

Embodiments of the second aspect of the present disclosure can include any one or a combination of the following features:
the controller actuates the cargo box from a first position to a second position and determines a change in power due to aerodynamic drag, and wherein the controller further selects one of the first or second positions based on the change in power indicative of least aerodynamic drag;
the actuator actuates the cargo box along a longitudinal axis of the motor vehicle between rearward and forward positions;
a yaw sensor for sensing yaw of the motor vehicle, wherein the controller further determines the position of the cargo box based on the sensed yaw;
the sensed yaw is an estimated yaw angle;
a vehicle speed sensor, wherein the controller determines when the motor vehicle is parked and further detects a request to open the rear liftgate, and wherein the controller actuates the actuator to move the cargo box to a rearward position;
the actuator comprises an electric motor and a screw jack;
the cargo box has a power cable connected to an electrical connector on the motor vehicle; and
the electrical connector comprises a trailer connector electrical plug.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a sideview of a motor vehicle having an aerodynamically tunable cargo box carrier mounted to a hitch at the rear end of the motor vehicle with the cargo box shown in a first position;

FIG. 1B is a sideview of a motor vehicle having the cargo box shown in an extended second position;

FIG. 2 is a block diagram illustrating a cargo box carrier positioning system having controls for controlling the position of the cargo box, according to one example; and

FIG. 3 is a flow diagram illustrating a routine for controlling the position of the cargo box to enhance vehicle aerodynamics.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

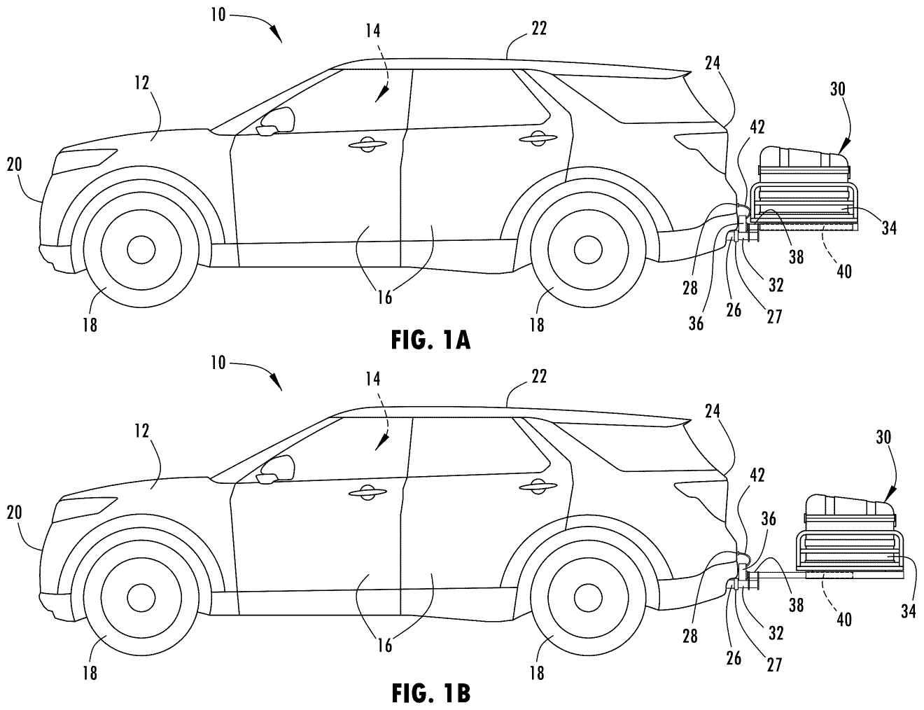

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle having an adjustable cargo box carrier. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, an automotive or motor vehicle 10 is generally illustrated in the form of a wheeled passenger vehicle configured as a sport utility vehicle (SUV), according to one example. The motor vehicle 10 has a body 12 which generally defines a cabin interior 14. The body 12 typically has body panels, windows, a windshield, and includes a front end 20, a rear end 24, side doors 16 and a roof 22. The motor vehicle 10 is also equipped with a plurality of wheel and tire assemblies 18 that roll on the ground or roadway. The cabin interior 14 generally defines a passenger compartment that typically includes a plurality of seat assemblies to accommodate a driver and passengers. It should be appreciated that the motor vehicle 10 may be equipped with various accommodations and accessories and may otherwise be configured in another vehicular form such as a sedan, a truck, a van, a bus, a motor home or other configurations of a motor vehicle.

The motor vehicle 10 is shown equipped with a hitch 26 at the rear end 24 of the motor vehicle 10. The motor vehicle 10 shown and described herein has the hitch 26 configured such that it may be used as a tow hitch to tow a trailer or to receive and hold a hitch mounted device such as a cargo box carrier 30. The hitch 26 is mounted via welding or fasteners to the vehicle frame near the rear end 24 of the motor vehicle 10 and extends rearward from the motor vehicle 10 below a rear bumper. The vehicle hitch 26 includes a hitch receiver 27 generally extending rearward from the motor vehicle 10. The hitch receiver 27 is configured to receive a hitch connector, such as a draw bar 32 which may be fixedly attached with a locking pin. The draw bar 32 may be configured with a hitch ball configured to connect with a tow bar of a trailer that may be towed with the motor vehicle 10 or may be part of a cargo box carrier 30 having a cargo box 34 configured to transport cargo items.

In addition, the hitch 26 includes an electrical connector 28 configured to connect with an electrical connector on the cargo box carrier 30. The electrical connector 28 typically includes electrical powered contacts for supplying electrical power to power and control trailer lights, such as brake lights and turn signals, and braking when connector to a trailer. When connected to the cargo box carrier 30, the electrical connector 16 is connected to cable 42 which in turn supplies vehicle electrical power to an actuator 36 that actuates movement of the cargo box 34. The cable 42 may also include communication signals for communicating the position of the cargo box 34 relative to the draw bar 32 and controlling movement of the cargo box carrier 30.

The motor vehicle 10 is shown in FIGS. 1A and 1B having the adjustable cargo box carrier 30 connected to the hitch 26, specifically being mounted to the hitch receiver of the hitch 26. The adjustable cargo box carrier 30 includes a cargo box 34 generally configured to hold one or more cargo items for transport with the motor vehicle 10. The cargo box 34 may have various shapes and sizes and may affect the vehicle aerodynamics depending on the shape and size of the cargo box 34 and the location of the cargo box 34 relative to the motor vehicle 10. The adjustable cargo box carrier 30 has a draw bar 32 configured to mattingly connect into the hitch receiver of the hitch 26 such that the adjustable cargo box carrier 30 once installed is fixedly connected at the rear end 24 of the motor vehicle 10. The adjustable cargo box carrier 30 has an actuator 36 which may include an electric motor, according to one example. The actuator 36 is operatively coupled to a rotary to linear transformation device such as a screw jack 40. The screw jack 40 may be used to transform rotary movement of the motor output shaft to linear movement to move the cargo box 34 along the vehicle longitudinal axis between a forward position shown in FIG. 1A and a rearward position shown in FIG. 1B and any intermediate positions. In doing so, the motor actuator 36 may have an output shaft that rotates the jack screw 40 which in turn linearly moves the cargo box 34 vehicle forward or rearward. Other examples of actuators may include the use of rollers on a rail and magnetic actuators. It should be appreciated that the cargo box 34 on the adjustable cargo box carrier 30 may be in the forwardmost position shown in FIG. 1A, or in the rearward most position shown in 1B, or any position in between the first position and the second position.

The adjustable cargo box carrier 30 is controlled to move the cargo box 34 by a controller which controls the actuator 36 to translate and thereby move the cargo box 34 amongst a plurality of positions based on feedback indicative of vehicle aerodynamics from the vehicle power management system and other sensors so as to enhance the aerodynamics by reducing or minimizing aerodynamic drag of the combined motor vehicle 10 and the cargo box carrier 30. When the motor vehicle 10 is moving, the adjustable cargo box carrier 30 may be actuated to move the cargo box 34 between different positions and the feedback received from the vehicle power management system and other sensors may be used to determine the energy usage or power levels of the motor vehicle 10 which are at least in part indicative of the aerodynamic drag load on the motor vehicle 10. The controller may actuate the adjustable cargo box carrier 30 to move the cargo box 34 from the first position to a second position and monitor the feedback to determine if the motor vehicle has more drag or less drag. The controller then selects the position of the cargo box 34 that has less drag as a new default position. The controller may repeatedly actuate the cargo box 34 between different positions and monitor the feedback to find the optimal position while the motor vehicle 10 is traveling.

The motor vehicle 10 controls the position of the cargo box 34 of the adjustable cargo box carrier 30 with the use of a cargo box positioning control system to minimize the aerodynamic drag of the motor vehicle 10 and cargo box carrier 30 to thereby enable achievement of an enhanced driving range based on external air flow conditions as air flows around the motor vehicle 10 and the cargo box carrier 30 during travel. The cargo box 34 may be moved rearward close to the aerodynamic wake shear layer to help stabilize the wake and therefore reduce the aerodynamic drag under nominal external air flow conditions. With the motor vehicle 10 driving at higher speeds, such as highway driving speeds, the vehicle power management system can monitor and calculate the lowest energy and/or power position of the cargo box 34. The lowest energy or power position may be compared with different positions of the cargo box 34 to determine which position achieves the lowest drag. It should be appreciated that external acrodynamic conditions such as crosswind could affect the optimal position of the cargo box 34. For example, with low wind, the cargo box 34 may deploy rearward into the acrodynamic minimized power position, whereas with the high wind or a heavy crosswind, the cargo box 34 may be retracted forward towards the vehicle and thereby move forward to reduce the distance between the motor vehicle 10 and the cargo box 34 to reduce drag.

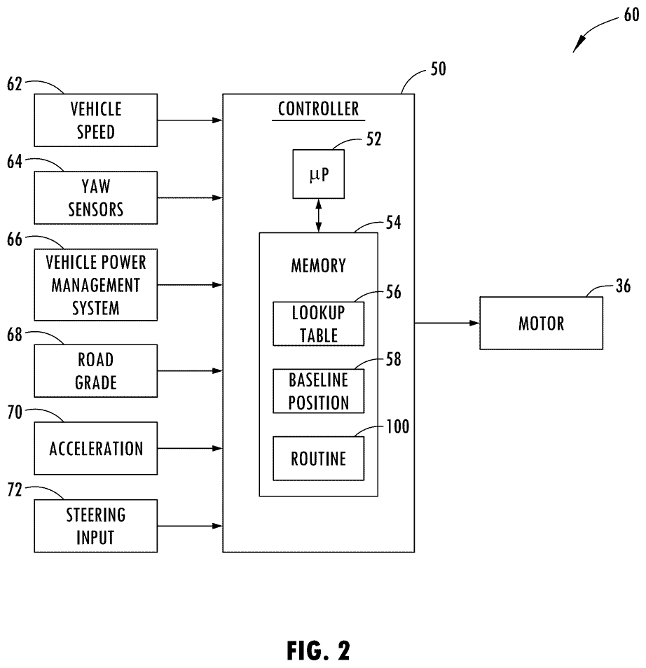

Referring to FIG. 2, a cargo box positioning control system 60 is generally illustrated having the controller 50 configured to receive various inputs and to control the actuator motor 36 to move the cargo box 34. According to one example, the controller 50 may be located on the motor vehicle 10 and may include a shared or dedicated controller. According to another example, the controller 50 may be located on the adjustable cargo box carrier 30 and configured to communicate with a vehicle power management system and sensors onboard the motor vehicle 10. The controller 50 may include a microprocessor or other analog and/or digital control circuitry. In the example shown, the controller 50 has a microprocessor 52 and memory 54. Stored within memory 54 and executed by the microprocessor 52 is a lookup table 56, a baseline position 58 and a control routine 100. The lookup table 56 may include the aerodynamic drag values for various feedbacks received from the vehicle power management system and other sensors. For example, the lookup table may include preferred positions of the cargo box 34 for certain parameters related to the vehicle and the cargo box carrier for different speeds, crosswinds, grades and other factors that may affect the vehicle and cargo box aerodynamics. The baseline position 58 may include the default positions and updated positions of the adjustable cargo box 34.

The controller 50 receives the vehicle speed signal from the vehicle speed sensors 62 and an estimated yaw signal from one or more aerodynamic yaw sensors 64. The vehicle power management system 66 is shown providing the feedback input to the controller 50. The controller 50 may also receive a road grade signal from a road grade sensor which may include the inclination angle of the motor vehicle as it travels. Further, the controller 50 receives an acceleration signal from an acceleration sensor 70, indicative of the acceleration or deceleration of the motor vehicle 10. Finally, the controller 50 receives a steering signal from a steering input 72 indicative of the steering angle of the motor vehicle. The controller 50 processes the various inputs and based on the control routine 100 and the lookup table 56 and the baseline position 58, determines a position of the cargo box 34 of the adjustable cargo box carrier 30, and controls the actuator 36 to move the cargo box 34 to an optimal position.

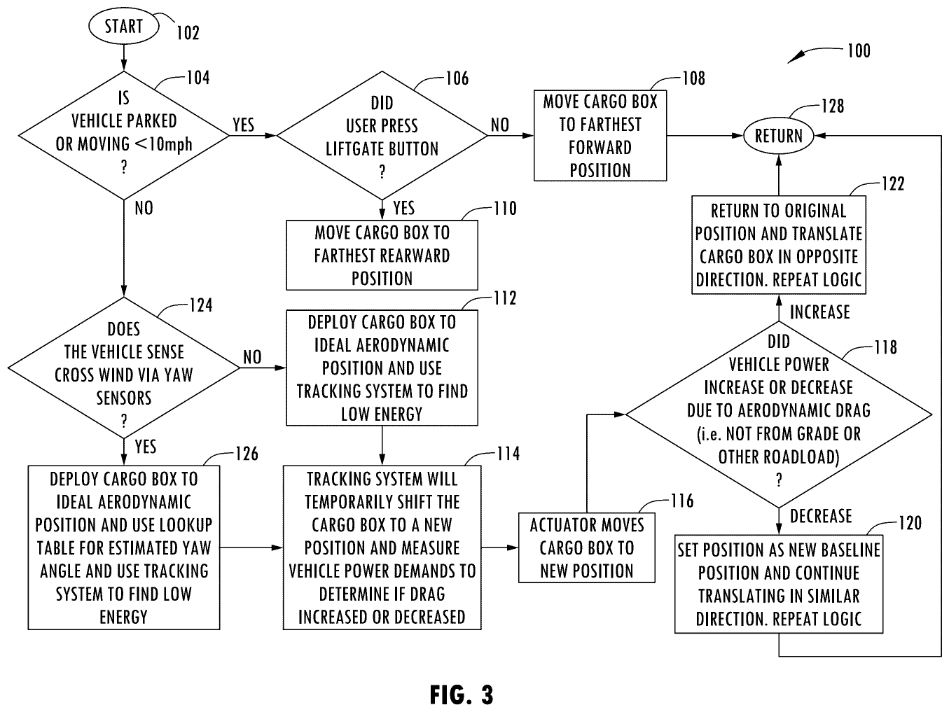

Referring to FIG. 3, the control routine 100 for controlling the adjustable cargo box carrier 30 is shown according to one embodiment. Control routine 100 starts at step 102 and proceeds to decision step 104 to determine if the motor vehicle is parked or moving at a speed of less than a low speed of ten miles per hour, for example. If the motor vehicle is parked or moving at a slow speed of less than ten miles per hour, routine 100 proceeds to decision step 106 to determine if a customer user has pressed the rear liftgate button to open the rear liftgate and, if so, moves the cargo box to the farthest rearward position at step 110. This enables the liftgate to open without any interference from the cargo box.

If the customer user does not press the liftgate button, control routine 100 proceeds to step 108 to move the cargo box to the farthest forward position at step 108, before returning to step 128. Accordingly, the cargo box initially remains in the farthest forward position closest to the motor vehicle when the motor vehicle is stopped or moving at a slow speed of less than ten miles per hour and the liftgate is not open. This minimizes the overall length of the vehicle for low speed driving, turning, and parking conditions.

If the motor vehicle is determined to be moving at a speed greater than ten miles per hour, control routine 100 proceeds to decision step 124 to determine if the motor vehicle senses a crosswind with one or more aerodynamic yaw sensors. If no crosswind is sensed, routine 100 proceeds to step 112 to deploy the cargo box to an ideal aerodynamic position and to use tracking to find low energy usage of the motor vehicle. Proceeding to step 114, the tracking system will temporarily shift the cargo box to a new position and measure the motor vehicle power demands to determine if the aerodynamic drag has increased or decreased. If the motor vehicle senses a crosswind, routine 100 proceeds to step 126 to deploy the cargo box to an ideal aerodynamic position and uses the lookup table for estimating the aerodynamic yaw and uses the tracking system to find the low energy usage by the motor vehicle.

The aerodynamic yaw may be estimated using one or more vehicle yaw rate sensors in combination with the sensed vehicle road grade and the steering wheel input to determine when the vehicle experiences an unexpected yaw rate that is not caused by the road grade or steering wheel input, but instead is caused by the aerodynamic crosswind, according to one example. According to another example, the acrodynamic yaw may be estimated using two or more aerodynamic pressure sensors and detecting the difference between the sensed pressure on either side of the vehicle to estimate yaw. As a result, the estimated acrodynamic yaw may be used to adjust the position of the cargo box to achieve an enhanced aerodynamic position.

Once the tracking system temporarily shifts the cargo box to a new position and measures the motor vehicle power demands to determine if the aerodynamic drag has increased or decreased in step 114, control routine 100 proceeds to step 116 to control the actuator to move the cargo box to a new position. The new position of the cargo box may be an incremental movement of the cargo box or may be any movement between the fully forward and rearward positions. Next, at decision step 118, control routine 100 determines if the motor vehicle power increases or decreases due to aerodynamic drag. It should be appreciated that aerodynamic drag may not include power increases or decreases otherwise realized from the grade of the road or other road load. If the motor vehicle power increases, control routine 100 proceeds to step 122 to return the cargo box to the original position which was last set as the default baseline position and instructs the controller to translate the cargo box in the opposite direction and to repeat the logic. If the vehicle power has decreased in the new position, the new position is set as the new baseline position and continues translating the cargo box in the same direction and instructs the controller to repeat the logic. As such, the controller may continuously move the position of the cargo box and tests for a decrease in aerodynamic drag to determine a new baseline position of the cargo box.

Accordingly, the motor vehicle 10 advantageously provides for an adjustable cargo box carrier 30 that may be mounted to the hitch 26 of the motor vehicle 10 and has an actuator 36 to move the cargo box 34 relative to the motor vehicle 10 between forward and rearward positions to enhance the aerodynamics to minimize drag on the motor vehicle 10. This may result in enhanced motor vehicle performance such as enhanced driving range and reduced energy usage. It should be further appreciated that the actuator 36 may be configured to move the adjustable cargo box 34 in other directions to further enhance the aerodynamics of the motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A motor vehicle comprising:
a hitch mounted to a rear end of the motor vehicle;
a vehicle power management system configured to detect power or energy levels of the motor vehicle and to generate feedback indicative of aerodynamics of the motor vehicle;
a cargo box carrier mounted to the hitch, the cargo box carrier having an adjustable cargo box and an actuator configured to move the cargo box relative to the motor vehicle; and
a controller for controlling the actuator to move the cargo box based on feedback from the vehicle power management system.

2. The motor vehicle of claim 1, wherein the controller actuates the cargo box from a first position to a second position and determines a change in power due to aerodynamic drag, and wherein the controller further selects one of the first or second positions based on the change in power indicative of least aerodynamic drag.

3. The motor vehicle of claim 2, wherein the actuator actuates the cargo box along a longitudinal axis of the motor vehicle between rearward and forward positions.

4. The motor vehicle of claim 3, further comprising a yaw sensor for sensing yaw of the motor vehicle, wherein the controller further determines the position of the cargo box based on the sensed yaw.

5. The motor vehicle of claim 4, wherein the sensed yaw is an estimated yaw angle.

6. The motor vehicle of claim 4, wherein the sensed yaw is indicative of a crosswind load on the motor vehicle.

7. The motor vehicle of claim 1, further comprising a vehicle speed sensor, wherein the controller determines when the motor vehicle is parked and further detects a request to open the rear liftgate, and wherein the controller actuates the actuator to move the cargo box to a rearward position.

8. The motor vehicle of claim 1, wherein the cargo box carrier further comprises a draw bar configured to mount to the hitch.

9. The motor vehicle of claim 1, wherein the actuator comprises an electric motor and a screw jack.

10. The motor vehicle of claim 8, wherein the cargo box has a power cable connected to an electrical connector on the motor vehicle.

11. The motor vehicle of claim 9, wherein the electrical connector comprises a trailer connector electrical plug.

12. A motor vehicle comprising:
a hitch mounted to a rear end of the motor vehicle;
a vehicle power management system configured to detect power or energy levels of the motor vehicle and to generate feedback indicative of aerodynamics of the motor vehicle;
a cargo box carrier having a draw bar connected to the hitch and an adjustable cargo box coupled to the draw bar, the cargo box carrier having an actuator configured to move the cargo box relative to the motor vehicle between a forward position and a rearward position; and
a controller for controlling the actuator to move the cargo box based on feedback from the vehicle power management system.

13. The motor vehicle of claim 12, wherein the controller actuates the cargo box from a first position to a second position and determines a change in power due to aerodynamic drag, and wherein the controller further selects one of the first or second positions based on the change in power indicative of least aerodynamic drag.

14. The motor vehicle of claim 13, wherein the actuator actuates the cargo box along a longitudinal axis of the motor vehicle between rearward and forward positions.

15. The motor vehicle of claim 12, further comprising a yaw sensor for sensing yaw of the motor vehicle, wherein the controller further determines the position of the cargo box based on the sensed yaw.

16. The motor vehicle of claim 15, wherein the sensed yaw is an estimated yaw angle.

17. The motor vehicle of claim 12, further comprising a vehicle speed sensor, wherein the controller determines when the motor vehicle is parked and further detects a request to open the rear liftgate, and wherein the controller actuates the actuator to move the cargo box to a rearward position.

18. The motor vehicle of claim 12, wherein the actuator comprises an electric motor and a screw jack.

19. The motor vehicle of claim 18, wherein the cargo box has a power cable connected to an electrical connector on the motor vehicle.

20. The motor vehicle of claim 19, wherein the electrical connector comprises a trailer connector electrical plug.
